(19) United States
(12) Patent Application Publication
(10) Pub. No.: US 2017/0362683 A1
(43) Pub. Date: Dec. 21, 2017

(54) METHOD FOR PRODUCING ALUMINUM-COPPER ALLOY FROM LITHIUM ION SECONDARY BATTERY

(71) Applicant: SHINKO FREX Inc., Hamamatsu-shi (JP)

(72) Inventors: Kazuma TORII, Hamamatsu-shi (JP); Hiroyuki MATSUURA, Hamamatsu-shi (JP); Ryo MATSUI, Hamamatsu-shi (JP)

(73) Assignee: SHINKO FREX Inc., Hamamatsu-shi (JP)

(21) Appl. No.: 15/184,538

(22) Filed: Jun. 16, 2016

(51) Int. Cl. C22C 1/02; H01M 4/66; H01M 10/54; C22C 21/12; H01M 10/0525

(52) U.S. Cl. CPC C22C 1/026; H01M 10/54; C22C 21/12; H01M 4/661; H01M 10/0525

(57) ABSTRACT

A method for producing an aluminum-copper alloy from a lithium ion secondary battery includes supplying an aluminum source and a copper source derived from an aluminum-based positive electrode collector and a copper-based negative electrode collector, respectively, into a furnace, and melting the aluminum source and the copper source in a way that produces an alloy substantially free of a lithium component.

### BACKGROUND OF THE INVENTION

### 1. Field of the Invention

The present invention relates to a method for recovering valuable metals contained in a lithium ion secondary battery. Specifically, the invention, with a focus on the collectors, relates to a method for recovering aluminum and copper.

### 2. Description of Related Art

The lithium ion secondary batteries that are currently available use a negative electrode material, a positive electrode material, a separator, and an electrolytic solution that are sealed inside a bag- or case-like exterior member. The positive electrode active material is a lithium metal composite oxide.

Because of advantages such as lightness and high electrical capacitance, lithium ion secondary batteries have been used as secondary batteries for a wide range of portable devices, and the demand for their use in automobiles has rapidly increased over the last years.

The consequence is that increasing numbers of used batteries will generate. However, because of restrictions including the limited landfill spaces available, it is no longer acceptable to dispose used batteries in a careless manner as has been done in the past. For recycling, there is a strong need for improving the recovery rate of valuable metals, and reusing the recycled materials in a wide range of applications at low cost.

In response to such demands, JP-A-2007-122885 proposes a valuable metal recovery method. In this method, a battery is disassembled, and the disassembled materials are washed with alcohol or water to remove the electrolytic solution. The constituent metals of the collector are then separated and recovered using a wet method. The remaining lithium (Li) in the aqueous solution is concentrated by solvent extraction and reverse extraction, and recovered as a lithium carbonate solid.

The foregoing traditional method is entirely a wet process, and is costly because of the need for effluent treatment. In a recently developed lithium ion secondary battery, the positive electrode active material uses lithium manganese, which has characteristics comparable to the characteristics of lithium cobalt oxide. Because manganese is less expensive than cobalt in terms of an ingot price, it is expected that use of manganese will become mainstream in the future. However, it still will be unprofitable so long as the wet recovery method is used.

In an attempt to find a solution, methods that use a dry process are now being explored. As an example of such a method, JP-A-2012-193424 proposes a method for recovering a manganese-based alloy using a dry process. The method enables recovery of a Mn—Ni alloy in a profitable fashion.

The collector on the positive electrode material side, and the collector on the negative electrode material side are configured from an aluminum foil and a copper foil, respectively. Separation of these materials from the battery by a drying method without melting produces a product with high aluminum and copper contents. Particularly, a material with an even higher metal content is produced when the separated materials are processed by a spalling machine.

Currently, such high metal content materials are intended for use as copper additive materials for materials such as iron and steel after molding by a briquetting or compression process. However, this is not active recycling of materials containing large proportions of components that can be effectively utilized.

It might be possible to use a mixture of aluminum and copperas an additive material for aluminum alloys for casting. However, use of such a mixture as an additive material for aluminum alloys is not possible because a misrun occurs when lithium is contained in an amount as small as, for example, 100 ppm.

### SUMMARY OF THE INVENTION

It is accordingly an object of the present invention to provide a novel and useful method of producing an aluminum-copper alloy from a lithium ion secondary battery, whereby a substantially lithium-free aluminum-copper alloy ingot can be produced with good yield from a lithium ion secondary battery, and use of the product as an additive material for aluminum alloys is enabled.

The present invention has been made to find a solution to the foregoing problems, and an aspect of the invention is a method for producing an aluminum-copper alloy from a lithium ion secondary battery, the method including supplying an aluminum source and a copper source derived from an aluminum-based positive electrode collector and a copper-based negative electrode collector, respectively, into a furnace, and melting the aluminum source and the copper source in a way that produces an alloy substantially free of a lithium component.

In the aspect of the invention, the melting may be performed by being blocked from the atmosphere with a molten salt layer.

In the aspect of the invention, the molten salt layer may be formed using a chloride.

In the aspect of the invention, the chloride may be a mixture containing a salt.

In the aspect of the invention, the aluminum source and the copper source may be supplied onto an aluminum-based or an aluminum-copper-based base molten metal that is prepared in advance.

In the aspect of the invention, the aluminum source and the copper source may be supplied while stirring the base molten metal.

The method according to the aspect of the invention enables producing a substantially lithium-free aluminum-copper alloy with good yield from a lithium ion secondary battery.

### BRIEF DESCRIPTION OF THE DRAWINGS

FIG. 1 is a perspective view of a lithium ion secondary battery (laminate cell) used in an embodiment of the present invention.

FIG. 2 is an overall flowchart of a valuable metal recovery method including a method according to the embodiment.

FIG. 3 is a diagram representing a method according to part of the embodiment represented in FIG. 2.

FIG. 4 is a schematic diagram of a melting pot furnace and a stirrer used in the method according to the embodiment.

FIG. 5 shows pictures of materials used in Examples, specifically a blanked board of A3004P material, and a material with a high Al—Cu metal content produced with a high-speed rotary spalling machine.

### DESCRIPTION OF EMBODIMENTS

### Processing Object

The object to be processed is a lithium ion secondary battery.

The primary components of a lithium ion secondary battery are a positive electrode material, a negative electrode material, and a separator, which are sealed inside a bag- or case-like exterior member by being laminated via an electrolytic solution.

The exterior member has been configured from metal, and aluminum has been a mainstream material thereof.

The main components of the positive electrode material are a sheet-like positive electrode collector, and a positive electrode active material fixed to the positive electrode collector. The positive electrode collector, that is a currently mainstream, is configured from an aluminum foil. The positive electrode active material, that is a currently mainstream, is a lithium-containing composite metal oxide. The primary components of the negative electrode material are a sheet-like negative electrode collector, and a negative electrode active material fixed to the negative electrode collector. The negative electrode collector, that is currently mainstream, is configured from a copper or a copper alloy foil. The negative electrode active material, that is currently mainstream, is configured from graphite or other carbon materials capable of storing and releasing lithium.

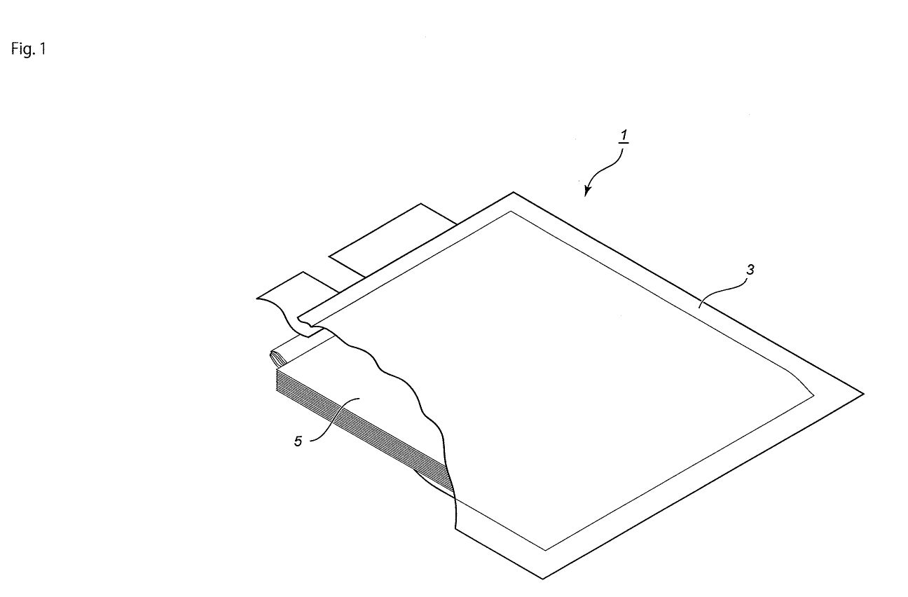

FIG. 1 illustrates an example of a lithium ion secondary battery 1 (about 30 cm×about 30 cm) having a form of a laminate cell. The lithium ion secondary battery 1 includes an exterior member 3 configured as an aluminum bag. The exterior member 3 houses a laminate 5 in which the positive electrode material, the separator, the negative electrode material, the separator, and the positive electrode material are alternately laminated. The lithium ion secondary battery 1 includes aluminum boards as the positive electrode, and copper boards with a nickel-plated surface as the negative electrode, and in general they are bundled.

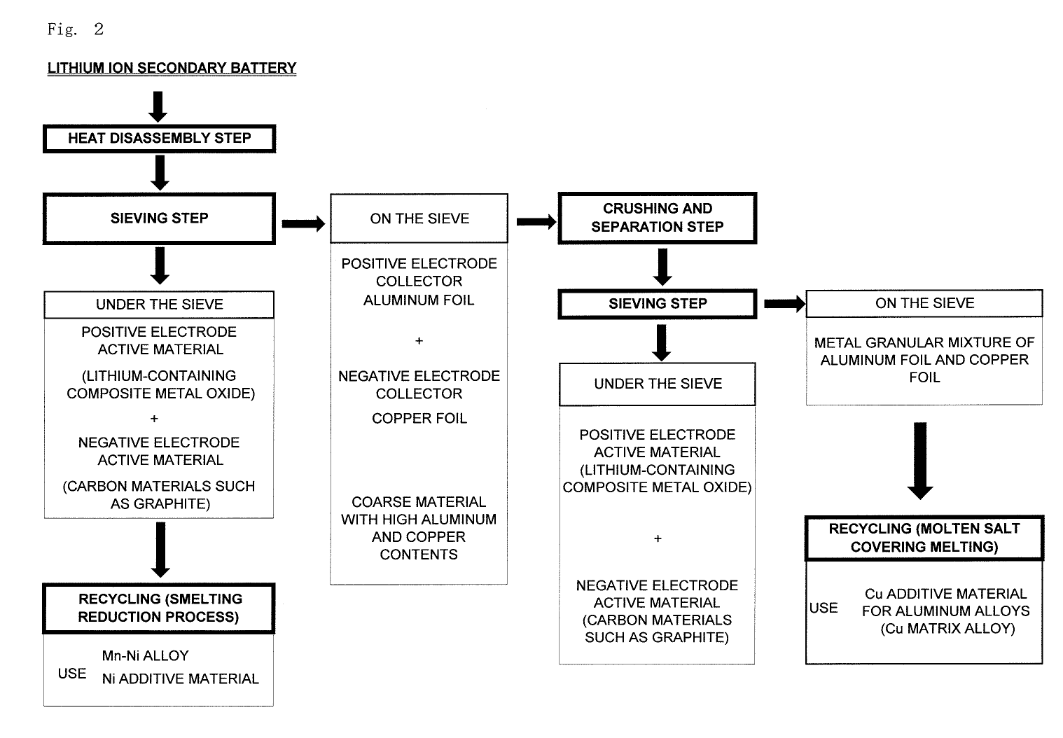

The lithium ion secondary battery 1 is recycled. FIG. 2 schematically represents the recycle procedures for the lithium ion secondary battery.

### Heat Disassembly Step

The lithium ion secondary battery is directly loaded into a rotary heating furnace, and burned by being fired with a burner while being rotated. The electrolytic solution quickly vaporizes upon the temperature inside the furnace reaching 500° C. or more, and self-combustion begins in a chain reaction once the combustion flame is ignited, even after the burner is turned off. This starts the heat disassembly step, causing the positive electrode material and the negative electrode material to separate from each other, and dissembling the battery.

Here, the spalled battery materials, including the positive electrode active material, and the negative electrode graphite fall through the punched inner walls of the furnace.

### Sieving Step

The battery materials from the furnace are sieved into coarse materials with high aluminum and copper contents, and fine materials containing a mixture of the lithium-containing composite metal oxide and the graphite.

The top materials on the sieve with high aluminum and copper contents, are subjected to a further process.

The materials under the sieve are recycled as a Mn—Ni alloy ingot product after a smelting reduction process.

### Crushing and Separation Step

The top materials with high aluminum and copper contents are crushed and separated, or, more specifically, spalled, with a high-speed rotary impact spalling machine, and sieved again to remove the positive electrode active material and the carbon powder. The sieving leaves a mixed granule of aluminum and copper having an even higher metal content, and measuring 0.25 mm or more in size as the top material on the sieve. This product is used as the object to be processed by the present invention, and recycled.

The materials under the sieve are also recycled as a Mn—Ni alloy ingot product after a smelting reduction process.

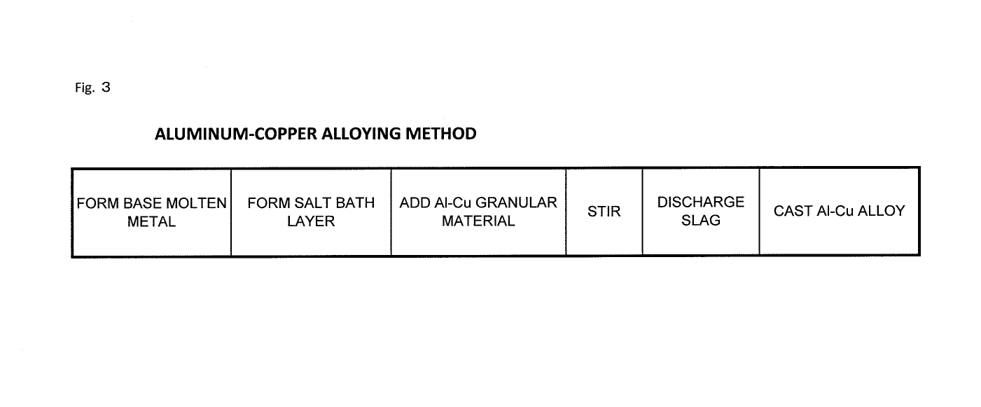

The alloy producing method of the present invention using the processing object granule is described below in detail with reference to FIG. 3.

FIG. 3 is a schematic diagram representing the processes performed by the alloy producing method in time series.

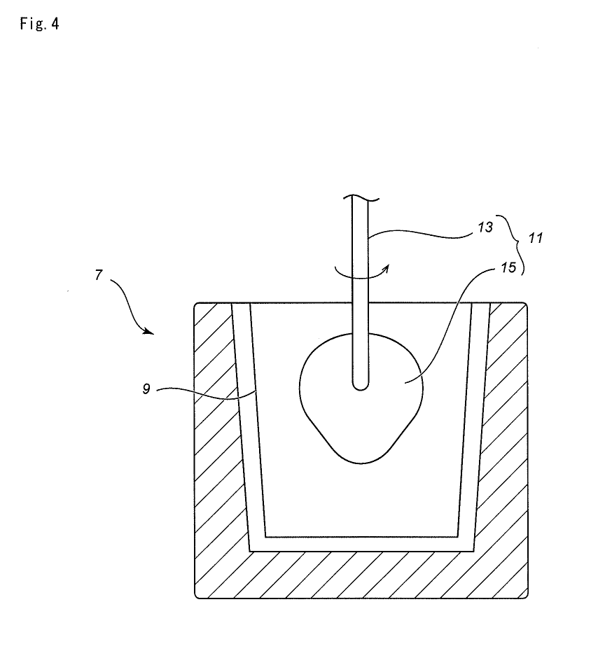

FIG. 4 illustrates a melting pot furnace 7. The melting pot furnace 7 has an open top, and houses a pot (bowl) 9. A gas burner is used as the heat source. The figure also shows a stirrer 11. The stirrer 11 has a supporting shaft 13, and a flat spurtle 15 attached at the bottom of the supporting shaft 13. The supporting shaft 13 is rotatable about its axis. When the supporting shaft 13 is rotated, the spurtle 15 rotates about the axis inside the pot 9, and stirs molten metal.

First, an aluminum material is supplied into the pot 9 of the melting pot furnace 7, and melted to prepare a base molten metal. The aluminum material is a blanked A3004P board. The aluminum material is supplied in amounts, according to the component specification of a desired aluminum-copper alloy product, to achieve the desired mixing ratio between the aluminum-copper granule and the base molten metal.

A chloride is supplied as a molten metal covering melting agent (flux) onto the base molten metal. The chloride is preferably a 1:1 mixture of NaCl and KCl by mass. This is because such a mixture, with its low melting point, can easily melt, and form a stable salt bath layer (molten salt layer) on the base molten metal. It is effective to use low-melting-point salts that do not generate harmful gas, or a mixture of such salts, as the chloride. Upon the formation, the salt bath layer covers the base molten metal, and blocks it from the atmosphere (oxygen). When too thick, the salt bath layer causes a heat loss, or inhibits transfer of the molten metal portion to the base molten metal side, as will be described later. On the other hand, when too thin, the salt bath layer fails to sufficiently cover the granular material, and portions of the granules become exposed. For these reasons, the salt bath layer has a thickness of preferably about 5 to 40 mm, more preferably about 20 to 40 mm when the granules are 30 mm or less.

As set forth above, the preparatory process is completed.

Stirring maintains a uniform molten metal temperature inside the pot 9. The stirring also provides drawing effect, as will be described later.

In this state, the materials with a high metal content, which have been disassembled and separated from the processing object lithium ion secondary battery, are supplied to the pot 9. Because the stirring creates a flow not only in the base molten metal but in the overlying salt bath layer, the supplied granules are quickly drawn into the salt bath layer from the uppermost layer in the flow created by stirring, and covered by the salt bath layer. This inhibits oxidation of the easily oxidizable aluminum.

In the salt bath layer, the metal product, specifically the aluminum and the copper melt by being heated, and move out of the salt bath layer, and mix with the base molten metal. Here, the lithium attached to the active material side of the positive electrode, and the lithium derived from the electrolytic solution are easily adsorbed also in the molten salt layer. Particularly, in the case of a salt bath layer, these lithium components combine with the chloride, and smoothly separate from the lithium metal composite oxide and the lithium organic compound side, and remain on the salt bath layer side.

In this manner, a molten metal of aluminum and copper is created in the pot 9, while the lithium forms a slag, and accumulates in the salt bath layer as the molten metal of aluminum and copper increases.

The molten metal removed from the pot 9 becomes an aluminum-copper alloy ingot upon being cooled. The ingot is produced in good yield, and is substantially lithium free, and can thus be used as an additive material for aluminum alloys.

Considering use as a copper additive material, the aluminum-copper alloy is preferably 33% copper, at which the eutectic point occurs. However, the proportion of copper is set to meet the required demands.

While there have been described an embodiment of the present invention, it will be understood that the present invention is not limited by the specific configurations above, and various design changes may be made thereto within the gist of the present invention, and it is intended that such modifications also fall within the scope of the invention.

For example, when a low-frequency induction furnace is used as the melting furnace, a separate stirrer will not be necessary because such a furnace functions to automatically stir the molten metal.

### EXAMPLES

The pot 9 is designed to accommodate 500 Kg of aluminum, and measures 865 mm in height, 876 mm in upper-end diameter, and 350 mm in bottom diameter. The volume is 326 L.

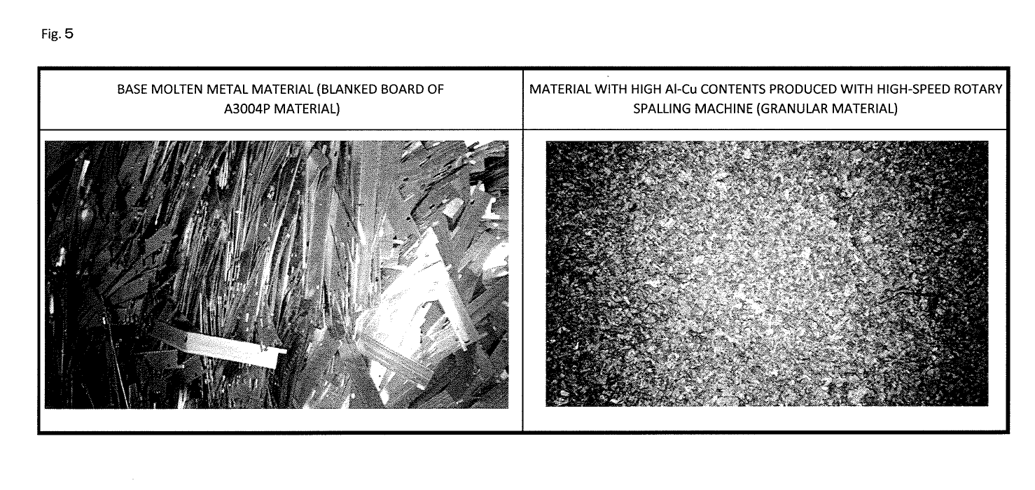

Materials, including the materials shown in FIG. 5, were supplied into the pot 9, and alloyed under the conditions below.

FIG. 5 shows pictures of a blanked board of A3004P material, and granules having a high metal content produced with a high-speed rotary spalling machine after a lithium ion secondary battery was disassembled and separated.

### Example 1

TABLE 1
Example 1 (Salt bath layer, about 5 mm)

| Input | Al and Cu material, shape | | 0.25 mm to 3 mm; granular | |
|---|---|---|---|---|
| | | | Supplied amounts | |
| | (Base molten metal) Al holder | | 150.0 Kg | |
| | Feedstock | 150 Kg | Al | 39.0 Kg |
| | (Amount calculated from component value) | | Cu | 102.8 Kg |
| | | | Other | 8.3 Kg |

| | | |
|---|---|---|
| Flux | NaCl:KCl = 1:1 | 5.0 Kg |
| | Thickness | About 5 mm |

| | Oxidation reaction suppressor | 20.0 Kg |
|---|---|---|
| | Sub total | |
| | Grand total | |
| Output | Ingot weight | 201.0 Kg |
| | Slag amount | 163.0 Kg |

| | Ingot | | | | Slag | | | |
|---|---|---|---|---|---|---|---|---|
| | Weight | | | | | | | |
| | 201.0 Kg | | | | 163.0 Kg | | | |
| | Component | | | | | | | |
| | Cu | Al | Li | Total | Cu | M—Al | Li | Total |
| Analytical value | 19.6% | 78.0% | 1.3 ppm | | 31.7% | 26.6% | 322.0 ppm | |
| Weight | 39.4 Kg | 156.8 Kg | | 196.2 Kg | 51.7 Kg | 43.4 Kg | | 95.0 Kg |
| Alloying yield | 40.4% | 86.1% | | | | | | |

The oxidation reaction suppressor shown in the table is potassium chloride, which was used to suppress oxidation reaction while supplying the granular material. The granular feedstock was supplied in small divided portions.

This made it possible to reduce slag generation to some extent.

It has been confirmed by X-ray fluorescence diffraction analysis that significant amounts of LiCl, LiCO₂, and LiClO₄ are present in a slag. It was demonstrated that these were separated from the lithium of the lithium metal composite oxide contained in the positive electrode active material, and the lithium compound derived from the electrolytic solution.

### Example 2

TABLE 2
Example 2 (Salt bath layer, about 30 mm)

| Input | Al and Cu material, shape | | 0.25 mm to 3 mm; granular | |
|---|---|---|---|---|
| | | | Supplied amounts | |
| | (Base molten metal) Al holder | | 150.0 Kg | |
| | Feedstock | 150 Kg | Al | 39.0 Kg |
| | (Amount calculated from component value) | | Cu | 102.8 Kg |
| | | | Other | 8.3 Kg |

| | | |
|---|---|---|
| Flux | NaCl:KCl = 1:1 | 30.0 Kg |
| | Thickness | About 50 mm |

| | Oxidation reaction suppressor | 0.0 Kg |
|---|---|---|
| | Sub total | |
| | Grand total | |
| Output | Ingot weight | 262.0 Kg |
| | Slag amount | 68.0 Kg |

| | Ingot | | | | Slag | | | |
|---|---|---|---|---|---|---|---|---|
| | Weight | | | | | | | |
| | 262.0 Kg | | | | 68.0 Kg | | | |
| | Component | | | | | | | |
| | Cu | Al | Li | Total | Cu | M—Al | Li | Total |
| Analytical value | 28.2% | 69.1% | 15.9 ppm | | 23.2% | 6.6% | 322.0 ppm | |
| Weight | 73.9 Kg | 181.0 Kg | | 254.9 Kg | 15.7 Kg | 4.5 Kg | | 20.2 Kg |
| Alloying yield | 75.7% | 99.4% | | | | | | |

The granular feedstock smoothly melted, and an oxidation reaction did not occur, even though the entire amount was supplied at once.

It has been confirmed by X-ray fluorescence diffraction analysis that significant amounts of LiCl, LiCO₂, and LiClO₄ are present in a slag. It was demonstrated that these were separated from the lithium of the lithium metal composite oxide contained in the positive electrode active material, and the lithium compound derived from the electrolytic solution.

The yield also significantly improved.

It was confirmed from this result that the effect prominently improves when the salt bath layer has a certain thickness.

The ingot was nearly a eutectic composition.

### Comparative Example 1

For comparison with Example 2, an experiment was conducted without the flux, specifically without the salt bath layer. The results are as follows.

TABLE 3
(With salt bath layer)

| | | | Main components | | | Yield of added material |
|---|---|---|---|---|---|---|
| | | | Al | Cu | Li | in molten metal |
| Feedstock | Base molten | Al holder | 95.5% | | | ≧90% |
| | metal material | | | | | |
| | Added material | Al and Cu | 26.0% | 68.5% | 0.28% | |
| | | granules | | | | |

| | | | | |
|---|---|---|---|---|
| Ingot | Al(70%)—Cu(30%) alloy | 69.0% | 30.0% | 0.001% |

TABLE 4
(Without salt bath layer)

| | | | Main components | | | Yield of added material |
|---|---|---|---|---|---|---|
| | | | Al | Cu | Li | in molten metal |
| Feedstock | Base molten | Al holder | 95.5% | | | ≦50% |
| | metal material | | | | | |
| | Added material | Al and Cu | 26.0% | 68.5% | 0.28% | |
| | | granules | | | | |

| | | | | |
|---|---|---|---|---|
| Ingot | Al(83%)—Cu(15%) alloy | 84.0% | 15.0% | 0.19% |

As clearly demonstrated above, the yield can improve, and the lithium can be separated from the metal side by forming the molten salt layer using the alloying method of the present invention.

### INDUSTRIAL APPLICABILITY

With the method of the present invention, materials from a used lithium ion secondary battery, or materials produced in the production of a lithium ion secondary battery can be recycled in such a manner that the recycled materials contain large proportions of components that can be effectively utilized, and that the recycled product can be used in a wide range of applications with good cost performance, without producing wastes.

1. A method for producing an aluminum-copper alloy from a lithium ion secondary battery,
the method comprising supplying an aluminum source and a copper source derived from an aluminum-based positive electrode collector and a copper-based negative electrode collector, respectively, into a furnace, and melting the aluminum source and the copper source in a way that produces an alloy substantially free of a lithium component.

2. The method according to claim 1, wherein the melting is performed by being blocked from the atmosphere with a molten salt layer.

3. The method according to claim 2, wherein the molten salt layer is formed using a chloride.

4. The method according to claim 3, wherein the chloride is a mixture containing a salt.

5. The method according claim 1, wherein the aluminum source and the copper source are supplied onto an aluminum-based or an aluminum-copper-based base molten metal that is prepared in advance.

6. The method according to claim 5, wherein the aluminum source and the copper source are supplied while stirring the base molten metal.

7. The method according to claim 2, wherein the aluminum source and the copper source are supplied onto an aluminum-based or an aluminum-copper-based base molten metal that is prepared in advance.

8. The method according to claim 3, wherein the aluminum source and the copper source are supplied onto an aluminum-based or an aluminum-copper-based base molten metal that is prepared in advance.

9. The method according to claim 4, wherein the aluminum source and the copper source are supplied onto an aluminum-based or an aluminum-copper-based base molten metal that is prepared in advance.

10. The method according to claim 7, wherein the aluminum source and the copper source are supplied while stirring the base molten metal.

11. The method according to claim 8, wherein the aluminum source and the copper source are supplied while stirring the base molten metal.

12. The method according to claim 9, wherein the aluminum source and the copper source are supplied while stirring the base molten metal.
